(19) United States
(12) Patent Application Publication
(10) Pub. No.: US 2008/0170126 A1
(43) Pub. Date: Jul. 17, 2008

(54) Method and system for image stabilization

(75) Inventors: Marius Tico, Tampere (FI); Sakari Alenius, Lempaala (FI); Markku Vehvilainen, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/787,907

(22) Filed: Apr. 19, 2007

Related U.S. Application Data
(60) Provisional application No. 60/747,167, filed on May 12, 2006.

(51) Int. Cl. H04N 5/228

(52) U.S. Cl. 348/208.6

(57) ABSTRACT

A method of improving image quality of a digital image is provided. In particular, the motion blur in an image taken in a long exposure time is reduced by dividing the exposure time into several shorter periods and capturing a series of images in those shorter periods. Among the images, one reference image is selected and the remaining images are registered in reference to the reference image by image warping, for example. After identifying the pixels in each of the remaining images and the corresponding pixels in the reference image, a weighting factor is assigned to each of the pixels in the remaining images based on the similarity in the pixel values between the remaining images and reference image. A weight average operation is carried out to sum the corresponding pixels in the reference and the remaining images to generate the final image.

This application is based on and claims priority to a pending U.S. Provisional Patent Application Ser. No. 60/747,167, filed May 12, 2006, assigned to the assignee of the present invention.

### FIELD OF THE INVENTION

The present invention relates generally to image stabilization and, more particularly, to image stabilization by image processing and registration.

### BACKGROUND OF THE INVENTION

The problem of image stabilization dates back to the beginning of photography, and the problem is related to the fact that an image sensor needs a sufficient exposure time to form a reasonably good image. Any motion of the camera during the exposure time causes a shift of the image projected on the image sensor, resulting in a degradation of the formed image. The motion related degradation is called motion blur. Using one or both hands to hold a camera while taking a picture, it is almost impossible to avoid an unwanted camera motion during a reasonably long exposure or integration time. Motion blur is particularly easy to occur when the camera is set at a high zoom ratio when even a small motion could significantly degrade the quality of the acquired image. One of the main difficulties in restoring motion blurred images is due to the fact that the motion blur is different from one image to another, depending on the actual camera motion that took place during the exposure time.

The ongoing development and miniaturization of consumer devices that have image acquisition capabilities increases the need for robust and efficient image stabilization solutions. The need is driven by two main factors:

1. Difficulty to avoid unwanted motion during the integration time when using a small hand-held device (like a camera phone).

2. The need for longer integration times due to the small pixel area resulting from the miniaturization of the image sensors in conjunction with the increase in image resolution. The smaller the pixel area the fewer photons per unit time could be captured by the pixel such that a longer integration time is needed for good results.

Image stabilization is usually carried out in a single-frame method and a multi-frame method. In the single-frame method, optical image stabilization generally involves laterally shifting the image while the image is projected on the image sensor by optical or mechanical means in order to compensate for the camera motion. The single-frame method requires a complex actuator mechanism to effect the image shifting. The actuator mechanism is generally expensive and large in size. It would be advantageous and desirable to provide a method and system for image stabilization using the multi-frame method.

### SUMMARY OF THE INVENTION

The present invention involves a multi-frame solution. The solution is based on dividing a long exposure time into several shorter intervals and capturing several image frames of the same scene. The exposure time for each frame is reasonably short in order to reduce the motion blur degradation of the individual frames. The final output image is obtained by combining the individual frames either during the time of their capturing or after they are all captured. The operations involved in the process of generating the final image from the individual frames are as follows:

1. Reference frame selection: Select a reference image frame among the available frames.

2. Global image registration: Register each image frame with respect to the reference frame.

3. Corresponding pixel identification and weighting: Identify the pixels in the given frames that correspond to the pixels of the reference image. Weight each pixel in the given frames according to the degree of similarity between the pixel and the corresponding reference pixel.

4. Pixel fusion: Calculate the final value of each image pixel in the given frames by combining its value in the reference image with its corresponding values in the other frames.

Thus, the first aspect of the present invention provides a method of image stabilization. The method comprises:

adjusting geometrically the plurality of image frames in reference to a reference frame for providing a plurality of adjusted image frames, wherein each of the reference frame and the adjusted image frames comprises a plurality of pixels, each pixel having a pixel value, wherein each of the pixels in at least an image section of each adjusted image frame has a corresponding pixel in the reference frame; and

determining a weighting factor for each pixel in said at least image section based on similarity between the pixel values of said each pixel and a corresponding pixel for generating a resulting image frame based on the pixel value of said each pixel adjusted by the weighting factor and the pixel value of the corresponding pixel in the reference frame.

The method further comprises selecting the reference frame and said plurality of image frames among a plurality of input frames.

According to one embodiment of the present invention, the reference frame is selected based on a sharpness measure of the input frames.

According to another embodiment of the present invention, the reference frame is selected from a frame that has a shortest exposure time among the input frames. The frame that has the shortest exposure time can be the first frame of the input frames.

According to a different embodiment, the reference frame is selected from the first frame that meets a certain sharpness criteria among the input frames. The frames that do not meet the sharpness criteria can be removed in order to save the memory storage.

According to one embodiment of the present invention, the resulting image is generated based on a weighted average of the pixel value of said each pixel adjusted by the weighting factor in each of the plurality of image frames and the pixel value of the corresponding pixel in the reference frame.

According to one embodiment of the present invention, the image frames are adjusted based on a geometrical or coordinate transformation, the transformation may include rotation, translation, affine transformation, nonlinear warping, enlarging, shrinking or any combination thereof. An image registration or comparison operation may be used to determine how each of the image frames is adjusted.

According to one embodiment of the present invention, the image registration or comparison operation may include low-pass filtering each of the plurality of other frames for providing a plurality of smoothed image frames and low-pass filtering the reference frame for providing a smoothed reference frame; and comparing a portion of each smoothed image frame to a corresponding portion of the smoothed reference frames for providing an error image portion so as to determine how each of the image frames is adjusted.

The second aspect of the present invention provides an image processing system which includes a processor configured for receiving a plurality of image frames and a memory unit communicative to the processor, wherein the memory unit has a software application, the software application having programming codes for carrying out the image stabilization method.

The third aspect of the present invention provides an imaging device, such as a stand-alone digital camera, a digital camera disposed in a mobile phone or the like. The imaging device includes an image sensor, an image forming module for forming a plurality of image frames on the image sensor, a processor configured for receiving a plurality of image frames for generating a resulting image; and a memory unit communicative to the processor, wherein the memory unit has a software application, the software application having programming codes for carrying out the image stabilization method.

The fourth aspect of the present invention provides a software application product embodied in a computer readable storage medium having programming codes to carry out the image stabilization method.

The present invention will become apparent upon reading the description taken in conjunction with FIGS. 1 to 8.

### BRIEF DESCRIPTION OF THE DRAWINGS

FIG. 1 is a flowchart illustrating the multi-frame image stabilization process, according to the present invention.

FIG. 2 illustrates the concept of using pixel neighborhood to evaluate the degree of similarity between pixels in two images.

FIG. 3 illustrates the concepts of using inner block and outer block to speed up the process of pixel correspondence selection.

FIG. 4 is a flowchart illustrating the process of corresponding pixel identification and weighting based on a single pixel.

FIG. 5 is a flowchart illustrating the process of corresponding pixel identification and weighting based on a block of pixels.

FIG. 6 illustrates the selection of sampling points, according to one embodiment of the present invention.

FIG. 7 illustrates two sets of sampling points selected from different low-resolution images in the smooth image area.

FIG. 8 illustrates an electronic device having an imaging device and an image processor for image stabilization purposes.

### DETAILED DESCRIPTION OF THE INVENTION

The present invention provides a method and system for multi-frame image stabilization. The method can be further improved by estimating parameters of the geometrical transformation for use in image registration.

### Multi-Frame Image Stabilization

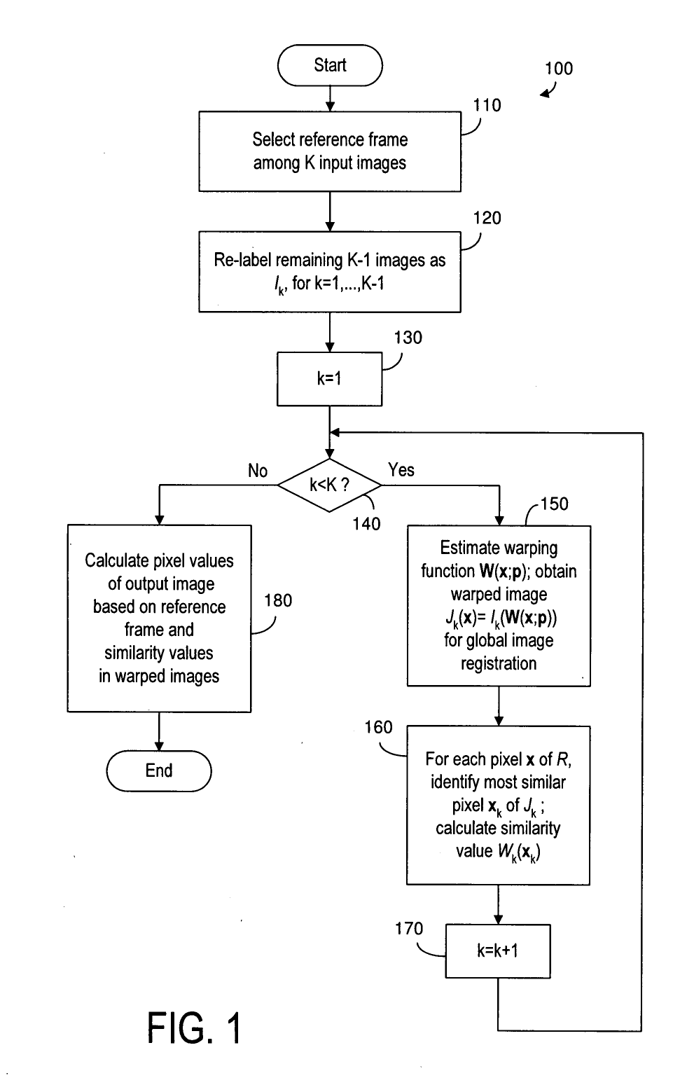

A general algorithmic description of the multi-frame image stabilization method, according to one embodiment of the present invention, is illustrated in the flowchart 100 in FIG. 1. The algorithm includes the following operations:

### Step 1. Reference Frame Selection

Select a reference image frame R among K available frames of the same scene, as shown at step 110. The selection can be based on image sharpness, for example. Image sharpness can be quantified by a sharpness measure. For example, the sharpness measure can be expressed as the sum of absolute values of the image after applying a band-pass filter:

$$Sharpness ( I ) = {\sum }_{x , y} abs ( {I}^{( bp )} ( x , y ) ) , \qquad ( 1 )$$

where I^{(bp)} denotes the band-pass filtered image. The filtered image can be obtained by filtering the original image in the frequency domain or in the spatial domain.

According to one embodiment of the present invention, the band-pass filtered image version is calculated as the difference between two differently smoothed versions of the original image:

I^{(bp)}(x,y)=abs(Ï_{L}_{₁}(x,y)−Ï_{L}_{₂}(x,y)), (2)

where L₁, and L₂ are different levels of image smoothness, and Ïₗ denotes a smoothed image resulted after l-th smoothing iterations. For example, L₁=4 (level 4) and L₂=1 (level 1) are used in the calculation of the band-pass filtered image version. Level 0 corresponds to the original image. Computation of the smoothed image version at different levels of smoothness is presented in more detail later herein.

Reference frame selection can be carried out in at least three ways. In a system where memory is sufficient, the image that exhibits the least blur or the highest sharpness among all available frames can be selected as the reference frame.

In a system where memory is strictly limited, it is usually not possible to store all intermediate images but only few of them (e.g. 2 or 3) plus the final result image. In such a case, the first image whose sharpness exceeds a certain threshold value is selected as the reference image. Moreover, it is possible that the system automatically removes all frames of which the sharpness measure is below a predetermined value as soon as they are captured.

A third option is to impose a shorter exposure time for one of the frames, such as the first frame, so as to reduce the risk of having it blurred by possible camera motion in that frame. The frame with a shorter exposure time can be selected as the reference frame.

### Step 2. Global Image Registration and Corresponding Pixel Identification

After the reference frame is selected among the K available frames, the remaining frames are re-labelled as Iₖ, k=1, . . . , K−1, as shown at step 120. For each of the remaining frames, the following steps are carried out through the loop with k<K (steps 140 through 170) starting with. k=1 (step 130).

a. Global Image Registration:

Global image registration, as illustrated at step 150, comprises two tasks:

i) Estimate a warping function (or the registration parameters) to be used in registering the image frame Iₖ with respect to the reference image R; and
ii) Warp the input image Iₖ based on the registration parameters estimated at the previous point. The warped input image is denoted as Jₖ. By warping, the input image Iₖ is adjusted by a geometrical or coordinate transformation. The transformation can be linear or non-linear, and the transformation may include rotation, translation, affine transformation, nonlinear warping, enlarging, shrinking or any combination thereof.

The objective of the global image registration process is to compare the corresponding pixels in two images, R and Jₖ, by overlapping them. In practice, exact pixel correspondence may not always be achievable in all image regions. For example, in the regions representing moving objects in the scene, or image regions that cannot be mapped by the assumed global motion model, exact pixel correspondence may not be achievable. For that reason, the step of corresponding pixel identification is also carried out.

b. Corresponding Pixel Identification and Weighting:

As illustrated at step 160, identification of corresponding pixels and assignment of weight are carried out separately:

i) For each pixel x=(x,y) in the reference image R, identify the corresponding pixel xₖ=(xₖ,yₖ) from the warped input image Jₖ.

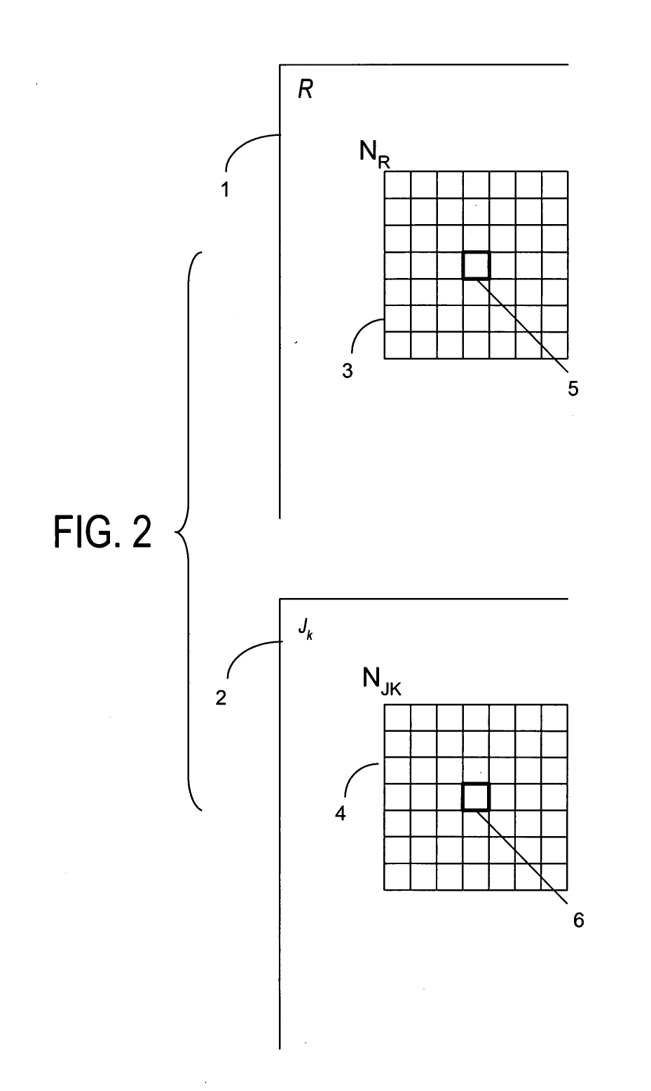

To improve the process, nearby pixels may also be used to aid the identification of the corresponding pixels. As illustrated in FIG. 2, the neighborhood 3 of a pixel 5 from reference image 1 and the neighborhood 4 of a pixel 6 from the registered and warped input image 2 are used to identify corresponding pixels in the warped input image 2 and the reference image 1. The neighborhood in the reference frame and that in the warped input image are denoted as N_{R} and N_{Jk}. For matching two such neighborhoods N_{R} and N_{Jk}, a distance function DF(N_{R},N_{Jk}) may be used. The distance function can be the mean absolute difference, or the mean square difference, etc.

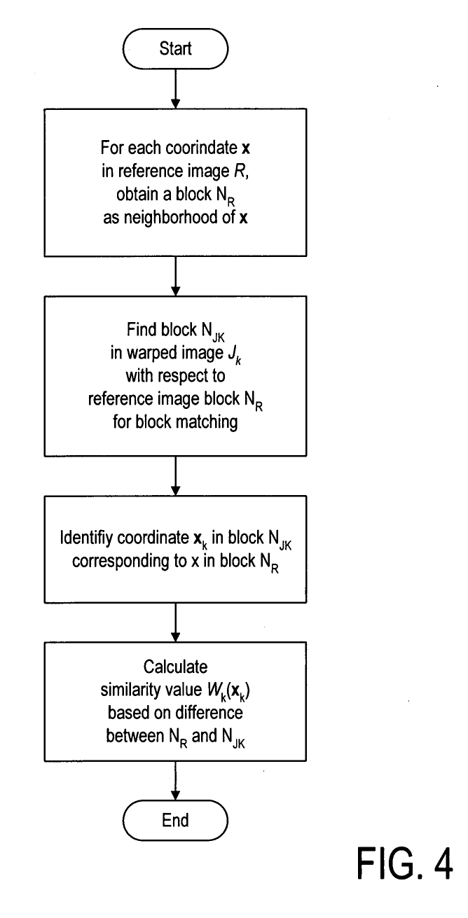

After the corresponding pixels are brought in close proximity from each other, a search for the corresponding pixel xₖ=(xₖ,yₖ) is carried out only in a restricted searching space around the coordinates x=(x,y). During the search, the corresponding pixel xₖ=(xₖ,yₖ) is selected as the pixel whose neighborhood N_{Jk} has a minimum distance DF(N_{R},N_{Jk}), with respect to the reference pixel neighborhood N_{R}. The search algorithm is summarized in the flowchart of FIG. 4.

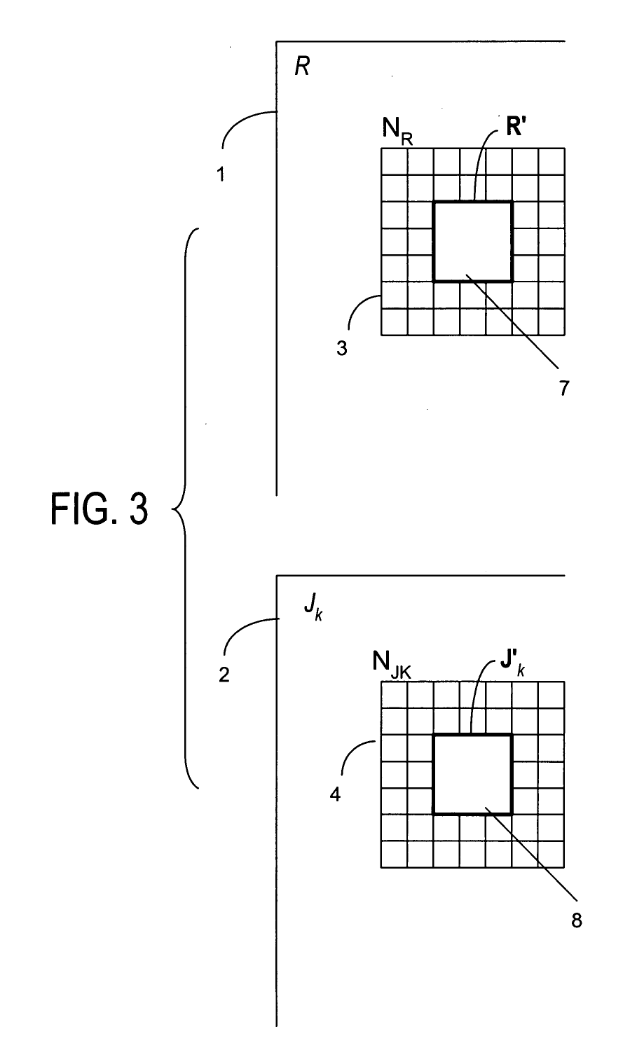

Alternatively, corresponding pixel identification is carried out simultaneously in blocks of pixels, called inner blocks, instead of individual pixels. The inner blocks are illustrated in FIG. 3. As illustrated in FIG. 3, inner block 8 (or J′ₖ) in the neighborhood 4 of warped input image 2 is compared to inner block 7 (or R′) in the neighborhood 3 (or the outer block N_{R}) in reference image 1 for corresponding pixel identification purposes.

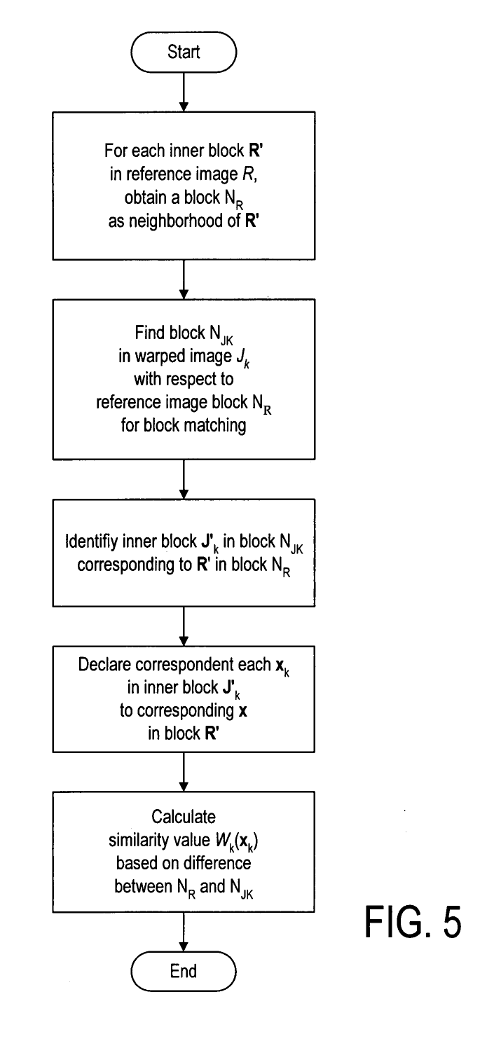

During the search, the inner block J′ₖ is selected as the block whose neighborhood or outer block N_{Jk} has a minimum distance DF(N_{R}, N_{Jk}), with respect to the outer block N_{R} of the inner block R′ in the reference image. The search algorithm using the inner blocks is summarized in the flowchart of FIG. 5.

In general, the process as illustrated in FIG. 5 is more efficient than the process as illustrated in FIG. 4. Moreover, if the inner block can be generalized to include only one pixel in the block, the two algorithms are identical.

ii) Weight the importance of each input image pixel Jₖ(xₖ) in the restoration of the reference image.

At this point each input image pixel has already assigned a corresponding pixel in the reference image. However this correspondence relationship may still be false in some image regions (i.e. moving objects regions). For that reason, a weight Wₖ(xₖ) may be assigned to each input image pixel in the pixel fusion process. It is possible to assign the same weight to all input image pixels that belong to the same inner block, and the weight is calculated based on a measure of similarity between the inner block and the best matching block from the reference image.

For instance, the measure of similarity can be represented by a function Wₖ(xₖ)=exp(−λ·DF(N_{R}, N_{Jk})), where λ is a real constant value. It is also possible that a small weight value is assigned to those pixels Jₖ(xₖ) that do not have corresponding pixels in the reference image. These pixels could be pixels belonging to some regions of the scene that have changed since the capture of the reference image (e.g. moving objects), or pixels belonging to some regions of the input image that are very different from the reference image (e.g. blur image regions since the reference image was selected to be the sharpest frame). This weighting process is useful in that better regions from each input image are selected for the construction of the output image. Optionally, in order to reduce subsequent computations, a minimum acceptable similarity threshold between two corresponding pixels can be set such that all the weights Wₖ(xₖ) that are smaller than the threshold can be set to zero.

### Step 3. Pixel Fusion

After the steps for global image registration, corresponding pixel identification and weighting on all remaining K−1 images are completed, pixel fusion is carried out at step 180 so as to produce an output image based on the reference frame and the similarity values in the warped images.

In pixel fusion, each pixel x of the output image O is calculated as a weighted average of the corresponding values in the K−1 warped images. The task is to calculate the final value of each pixel O(x). In this operation, all pixels in the reference image R are given the same weight W₀, whereas the corresponding pixels in the warped images will have the weights Wₖ(xₖ) as assigned in step 2(ii) above. The final image pixel is given by:

$$O ( x ) = \frac{{W}_{0} R ( x ) + {\sum }_{k = 1}^{K - 1} {W}_{k} ( {x}_{k} ) \cdot {J}_{k} ( {x}_{k} )}{{W}_{0} + {\sum }_{k = 1}^{K - 1} {W}_{k} ( {x}_{k} )} \qquad ( 3 )$$

### Corresponding Pixel Identification and Weighting

As mentioned earlier, a measure of similarity is used to assign the weight Wₖ(xₖ) for a corresponding pixel in a warped input image. For efficiency, pixels can be grouped into small blocks (inner blocks) of size 2×2 or larger, and all the pixels in such a block are treated unitarily, in the sense that they are all together declared correspondent with the pixels belonging to a similar inner block in the other image (see FIG. 3).

It is possible to speed up the process of corresponding pixel identification by:
(i) Applying the corresponding pixel identification step only to those pixels x=(x,y) in which the absolute difference between the two images abs(R(x)−Jₖ(x)) exceeds some threshold;
(ii) Restricting the searching space for the pixel xₖ=(xₖ,yₖ) around the coordinates x=(x,y) by a certain limit so that the search is only carried out after the corresponding pixels are already brought in close proximity from each other;
(iii) Using a known fast block matching algorithm for the pixel neighborhood matching process. For example, the matching algorithm called “Three-step search method” (see Yao Wang et al, “Video processing and communications”, Prentice Hall, 2002, page 159) can be used. In this fast block matching algorithm, the current block of the reference image N_{R} is compared with different blocks of the warped input image which are located inside a specified search area. By matching the reference block only against a small number of candidate blocks inside the search area, the searching space is effectively reduced. In addition, the algorithm iteratively reduces the size of the searching area by concentrating it in a neighborhood of the best solution discovered so far. The iterations stop when the searching area includes only one pixel.

### Estimation of Global Image Registration Parameters

A second aspect of the present invention provides a method for the estimation of the image registration parameters.

In the estimation process, only a smoothed version of each image is used for estimating the image registration parameters. The smoothed image is obtained by low-pass filtering the original image. Because a smoothed image represents an over-sampled version of the image, not all the pixels in the smoothed image are needed in the registration process. It is sufficient to use only a subset of the smoothed image pixels in the registration process. Moreover, various image warping operations needed during the estimation of the registration parameters can be achieved by selecting different sets of pixels inside the smoothed image area, without performing interpolation. In this way, the smoothed image is used only as a “reservoir of pixels” for different warped low-resolution versions of the image, which may be needed at different iterations.

The above-described estimation method is more effective when the images are degraded by blur (for example, out of focus blur and undesirable motion blur) and noise.

### Computation of the Smoothed Image Version

The smoothed image can be calculated by applying a low-pass filter on the original image, either in the frequency domain or in the spatial domain. The original image I can be iteratively smoothed in order to obtain smoother and smoother versions of the image. Let us denote by Ïₗ the smoothed image resulted after l-th smoothing iterations. At each such iteration, applying a one-dimensional low-pass filter along the image rows and columns in order to smooth the current image further. Thus, assuming Ï₀=I, the smoothed image at l-th iteration is obtained in two steps of one-dimensional filtering:

$${{\tilde{I}}_{l}}^{′} ( x , y ) = {\sum }_{c} {h}_{c} {\tilde{I}}_{l} ( x - {2}^{l} c , y ) , along image columns \\ {\tilde{I}}_{l + 1} ( x , y ) = {\sum }_{r} {h}_{r} {{\tilde{I}}_{l}}^{′} ( x , y - {2}^{l} r ) , along image rows , \qquad ( 4 )$$

where hₖ are the taps of the low-pass filter used. For example, it is possible to use a filter of size 3 having taps h₋₁=2⁻², h₀=2⁻¹, h₁=2⁻². The selection of filter taps as powers of 2 reduces the computational complexity since multiplication can be carried out in a shift register. At the end of this pre-processing step a smoothed image Ï_{L} of the same size with the original image is obtained. This smoothed image will be used in the registration operation.

### Algorithm for Estimation of Global Image Registration Parameters

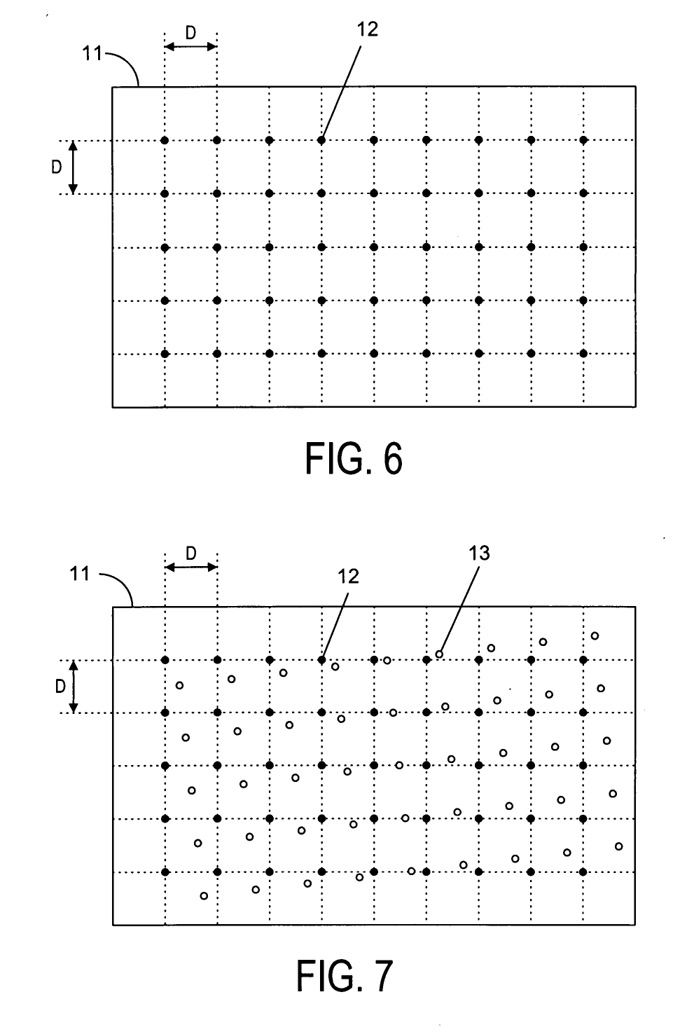

After the smoothed versions of the input and reference images are obtained, it is possible to select a set of sampling points in each image for image comparison. For simplicity, the sampling points are selected from the vertex of a rectangular lattice with horizontal and vertical period of D=2^{L} pixels. The selection of sampling points is illustrated in FIG. 6. In FIG. 6, reference numeral 11 denotes a smoothed image and reference numeral 12 denotes a sampling point. Accordingly, a low-resolution version of the input image can be obtained by collecting the values of the smoothed image pixels close to each selected sampling point x_{n,k}, i.e. Î(n,k)=Ï_{L}(x,k). Similarly, a low-resolution version of the reference image results as \hat{R}(n,k)=\ddot{R}_{L}(x_{n,k}).

In accordance with one embodiment of the present invention, warping of the input low-resolution image Î, is performed by changing the position of the sampling points x_{n,k} inside the smooth image area (see FIG. 7). Thus, given a warping function W(x,p), the warped input image is given by Î(n,k)=Ï_{L}(x′_{n,k}), where x′_{n,k}=round(W(x_{n,k},p)). In FIG. 7, reference numeral 13 denotes the changed position of the sample points after warping. As such, no interpolation is used as the new coordinates of the sampling points are rounded to the nearest pixels of the smoothed image.

A warping function can be selected in different ways. The selection of an appropriate parametric model for the warping function should be done in accordance with the expected camera motion and scene content. For instance, a simple model could be the two parameters translational model:

W(x;p)=x+p, (5)

where the parameter vector p=[p₁ p₂]^{T} includes the translation values along x and y image coordinates. Another example of warping functions that can be used in image registration applications is the rigid transformation:

$$W ( x ; p ) = [ \begin{matrix}cos {p}_{3} & sin {p}_{3} \\ - sin {p}_{3} & cos {p}_{3}\end{matrix} ] \cdot x + [ \begin{matrix}{p}_{1} \\ {p}_{2}\end{matrix} ] , \qquad ( 6 )$$

The rigid transformation consists of translation plus rotation.

Assuming a rigid warping function (Equation 6), the registration algorithm for registering an input image with respect to the reference image can be formulated as follows:

Input: the two images plus an initial guess of the parameter vector

p=[p₁ p₂ p₃]^{T}.

Output: the parameter vector that best overlaps the input image over the reference image.

### A. Pre-Computation:

a. Calculate the smoothed images Ï_{L}, \ddot{R}_{L}.

b. Set the initial position of the sampling points x_{n,k}, in the vertex of a rectangular lattice of period D=2^{L}, as exemplified in FIG. 6.

c. Construct the low-resolution reference image by collecting the pixels of the smoothed reference image in the sampling points, i.e. \hat{R}(n,k)=\ddot{R}_{L}(x_{n,k}).

d. Approximate the gradient of the reference image by

\hat{R}ₓ(n,k)=\hat{R}(n+1,k)−\hat{R}(n,k)+\hat{R}(n+1,k+1)−\hat{R}(n,k+1), and

\hat{R}_{y}(n,k)=\hat{R}(n,k+1)−\hat{R}(n,k)+\hat{R}(n+1,k+1)−\hat{R}(n+1,k).

e. Calculate an image

$${J}_{i} ( n , k ) = {\hat{R}}_{x} ( n , k ) \cdot \frac{\partial {W}_{x} ( x , 0 )}{\partial {p}_{i}} + {\hat{R}}_{y} ( n , k ) \cdot \frac{\partial {W}_{y} ( x , 0 )}{\partial {p}_{i}} , for$$

each parameter pᵢ of the warping function.

f. Calculate the 3×3 Hessian matrix:

$$H ( i , j ) = {\sum }_{n , k} {J}_{i} ( n , k ) {J}_{j} ( n , k ) .$$

g. Calculate the inverse of the Hessian matrix: H⁻¹.

### B. Iteration:

a. Warp the sampling points in accordance with the current warping parameters: x′_{n,k}=round(W(x_{n,k},p)).

b. Construct the warped low-resolution image by collecting the pixels of the input smoothed image in the sampling points: Î(n,k)=Ï_{L}(x′_{n,k}).

c. Calculate the error image: eₒ(n,k)=Î(n,k)−\hat{R}(n,k).

d. Smooth the error image:

e(n,k)=(eₒ(n,k)+eₒ(n+1,k)+eₒ(n,k+1)+eₒ(n+1,k+1))/4

e. Calculate the 3×1 vector of elements:

$$g ( i ) = {\sum }_{n , k} e ( n , k ) {J}_{i} ( n , k ) .$$

f. Calculate the update of the vector parameter: Δp=H⁻¹g.

g. Update the parameter vector such that:

$$p = p + [ \begin{matrix}D & 0 & 0 \\ 0 & D & 0 \\ 0 & 0 & 1\end{matrix} ]$$

Δp, where D is the period of the rectangular sampling lattice defined earlier in the sub-section A(b) above.

Thus, the present invention provides a method for image stabilization to improve the image quality of an image captured in a long exposure time. According to the present invention, the long exposure time is divided into several shorter intervals for capturing several image frames of the same scene. The exposure time for each frame is reasonably short in order to reduce the motion blur degradation of the individual frames. The final output image is obtained by combining the individual frames either during the time of their capturing or after they are all captured. The operations involved in the process of generating the final image from the individual frames are as follows:

1. Reference frame selection: Select a reference image frame among the available frames.

2. Global image registration: Register each image frame with respect to the reference frame.

3. Corresponding pixel identification and weighting: Identify the pixels in the given frames that correspond to the pixels of the reference image. Weight each pixel in the given frames according to the degree of similarity between the pixel and the corresponding reference pixel.

4. Pixel fusion: Calculate the final value of each image pixel in the given frames by combining its value in the reference image with its corresponding values in the other frames.

In sum, the method of image stabilization, according to the present invention, can be summarized in two operations as follows:

adjusting geometrically a plurality of image frames in reference to a reference frame for providing a plurality of adjusted image frames, wherein each of the reference frame and the adjusted image frames comprises a plurality of pixels, each pixel having a pixel value, wherein each of the pixels in at least an image section of each adjusted image frame has a corresponding pixel in the reference frame; and

determining a weighting factor for each pixel in said at least image section based on similarity between the pixel values of said each pixel and a corresponding pixel for generating a resulting image frame based on the pixel value of said each pixel adjusted by the weighting factor and the pixel value of the corresponding pixel in the reference frame.

If the reference image is not already selected, the reference frame can be selected among a plurality of input frames, based on different methods:

1) the reference frame is selected based on a sharpness measure of the input frames.

2) the reference frame is selected from a frame that has a shortest exposure time among the input frames. The frame that has the shortest exposure time can be the first frame of the input frames.

3) the reference frame is selected from the first frame that meets a certain sharpness criteria among the input frames. The frames that do not meet the sharpness criteria can be removed in order to save the memory storage.

According to one embodiment of the present invention, the resulting image is generated based on a weighted average of the pixel value of said each pixel adjusted by the weighting factor in each of the plurality of image frames and the pixel value of the corresponding pixel in the reference frame.

According to one embodiment of the present invention, the image frames are adjusted based on a geometrical or coordinate transformation, the transformation may include rotation, translation, affine transformation, nonlinear warping, enlarging, shrinking or any combination thereof. An image registration or comparison operation may be used to determine how each of the image frames is adjusted.

According to one embodiment of the present invention, the image registration or comparison operation may include low-pass filtering each of the plurality of other frames for providing a plurality of smoothed image frames and low-pass filtering the reference frame for providing a smoothed reference frame; and comparing a portion of each smoothed image frame to a corresponding portion of the smoothed reference frames for providing an error image portion so as to determine how each of the image frames is adjusted.

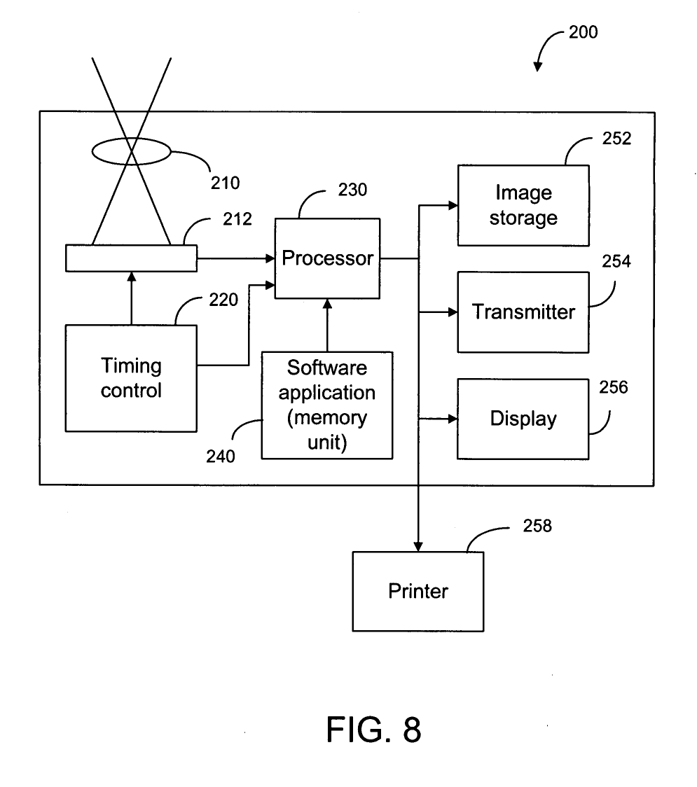

In order to carry out the image stabilization method, according to the various embodiments of the present invention, an image processing system is required. An exemplary image processing system is illustrated in FIG. 8.

FIG. 8 illustrates an electronic device that can be used for capturing digital images and carrying out the image stabilization method, according to the present invention. As shown in FIG. 8, the electronic device 200 has an image sensor 212 and an imaging forming module 210 for forming an image on the image sensor 212. A timing control module 220 is used to control the exposure time for capturing the image. A processor 230, operatively connected to the image sensor and the timing control module, for receiving one or more input images from the image sensor. A software application embodied in a computer readable storage medium 240 is used to control the operations of the processor. For example, the software application may have programming codes for dividing the exposure time of one image into several shorter periods for capturing several images instead. The software application may have programming codes for selecting one of the input images as the reference frame; adjusting the remaining image frames in reference to the reference frame for providing a plurality of adjusted image frames, and determining a weighting factor for each pixel in at least an image section based on similarity between the pixel values of each pixel and a corresponding pixel for generating a resulting image frame based on the pixel value of the pixel adjusted by the weighting factor and the pixel value of the corresponding pixel in the reference frame, for example.

The resulting image frame as generated by the processor and the software application can be conveyed to a storage medium 252 for storage, to a transmitter module 254 for transmitting, to a display unit 256 for displaying, or to a printer 258 for printing.

The electronic device 1, can be a stand-alone digital camera, a digital camera disposed in a mobile phone or the like.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of image stabilization, comprising:
adjusting geometrically a plurality of image frames in reference to a reference frame for providing a plurality of adjusted image frames, wherein each of the reference frame and the adjusted image frames comprises a plurality of pixels, each pixel having a pixel value, wherein each of the pixels in at least an image section of each adjusted image frame has a corresponding pixel in the reference frame; and
determining a weighting factor for each pixel in said at least image section based on similarity between the pixel values of said each pixel and the corresponding pixel for generating a resulting image frame based on the pixel value of said each pixel adjusted by the weighting factor and the pixel value of the corresponding pixel in the reference frame.

2. The method of claim 1, wherein said adjusting comprises:
comparing each of the plurality of image frames in reference to the reference frame for determining an estimated image registration parameter; and
performing a geometrical transformation on each of the image frames based on the estimated image registration parameter for providing the adjusted image frame.

3. The method of claim 2, wherein said comparing comprises:
low-pass filtering each of the plurality of image frames for providing a plurality of smoothed image frames;
low-pass filtering the reference frame for providing a smoothed reference frame; and
comparing at least a portion of each smoothed image frame to a corresponding portion of the smoothed reference frame for providing an error image portion so that the estimated image registration parameter is determined based on the error image portion.

4. The method of claim 1, further comprising
selecting the reference frame and said plurality of image frames among a sequence of input frames.

5. The method of claim 4, wherein said selecting is based on a sharpness measure of the input frames.

6. The method of claim 4, wherein each of the input frames has an exposure time, and the exposure time of the reference frame is shorter than the exposure time of at least some of the image frames.

7. The method of claim 6, wherein the sequence of input images include a first frame and the first frame is selected as the reference frame.

8. The method of claim 4, wherein the reference frame is selected from a first of the sequence of input frames that meets a sharpness criteria.

9. The method of claim 8, wherein the image frames are also selected based on the sharpness criteria.

10. The method of claim 1, wherein the resulting image is generated based on a weighted average of the pixel value of said each pixel adjusted by the weighting factor in each of the plurality of image frames and the pixel value of the corresponding pixel in the reference frame.

11. A software application product embodied in a computer readable storage medium having a software application, said software application comprising:
programming code for geometrically adjusting a plurality of image frames in reference to a reference frame for providing a plurality of adjusted image frames, wherein each of the reference frame and the adjusted image frames comprises a plurality of pixels, each pixel having a pixel value, wherein each of the pixels in at least an image section of each adjusted image frame has a corresponding pixel in the reference frame; and
programming code for determining a weighting factor for each pixel in said at least image section based on similarity between the pixel values of said each pixel and the corresponding pixel for generating a resulting image frame based on the pixel value of said each pixel adjusted by the weighting factor and the pixel value of the corresponding pixel in the reference frame.

12. The software application product of claim 11, wherein the programming code for adjusting comprises:
programming code for comparing each of the plurality of image frames in reference to the reference frame for determining an estimated image registration parameter; and
programming code for performing a geometrical transformation on each of the image frames based on the estimated image registration parameter for providing the adjusted image frame.

13. The software application product of claim 12, wherein said software application further comprises:
programming code for low-pass filtering each of the plurality of other frames for providing a plurality of smoothed image frames; and
programming code for low-pass filtering the reference frame for providing a smoothed reference frame; so that said comparing is based on a portion of each smoothed image frame and a corresponding portion of the smoothed reference frames for providing an error image portion so that the estimated image registration parameter is determined based on the error image portion.

14. The software application product of claim 11, wherein the reference frame is selected from a sequence of input frames based on a sharpness measure of the input frames, and wherein the software application further comprises
programming code for determining the sharpness measure.

15. The software application product of claim 14, wherein the software application further comprises
programming code for comparing the sharpness measure to a predetermined criteria so as to select a first of the sequence that meets the predetermined criteria as the reference frame.

16. The software application product of claim 11, wherein the resulting image is generated based on a weighted average of the pixel value of said each pixel adjusted by the weighting factor in each of the plurality of image frames and the pixel value of the corresponding pixel in the reference frame.

17. An image processing system, comprising:
a processor configured for receiving a plurality of image frames; and
a memory unit communicative to the processor, wherein the memory unit has a software application product according to claim 11.

18. An electronic device, comprising:
an image sensor;
an image forming module, for forming a plurality of image frames on the image sensor,
a processor configured for receiving the plurality of image frames; and
a memory unit communicative to the processor, wherein the memory unit has a software application comprising:
programming code for geometrically adjusting a plurality of image frames in reference to a reference frame for providing a plurality of adjusted image frames, wherein each of the reference frame and the adjusted image frames comprises a plurality of pixels, each pixel having a pixel value, wherein each of the pixels in at least an image section of each adjusted image frame has a corresponding pixel in the reference frame; and
programming code for determining a weighting factor for each pixel in said at least image section based on similarity between the pixel values of said each pixel and the corresponding pixel for generating a resulting image frame based on the pixel value of said each pixel adjusted by the weighting factor and the pixel value of the corresponding pixel in the reference frame.

19. The electronic device of claim 18, wherein the programming code for adjusting comprises:
programming code for comparing each of the plurality of image frames in reference to the reference frame for determining an estimated image registration parameter; and
programming code for performing a geometrical transformation on each of the image frames based on the estimated image registration parameter for providing the adjusted image frame.

20. The electronic device of claim 19, wherein said software application further comprises:
programming code for low-pass filtering each of the plurality of other frames for providing a plurality of smoothed image frames; and
programming code for low-pass filtering the reference frame for providing a smoothed reference frame; so that said comparing is based on a portion of each smoothed image frame and a corresponding portion of the smoothed reference frames for providing an error image portion so that the estimated image registration parameter is determined based on the error image portion.

21. The electronic device of claim 18, wherein the reference frame is selected from a sequence of input frames based on a sharpness measure of the input frames, and wherein the software application further comprises
programming code for determining the sharpness measure.

22. The electronic device of claim 21, wherein the software application further comprises
programming code for comparing the sharpness measure to a predetermined criteria so as to select a first of the sequence that meets the predetermined criteria as the reference frame.

23. The electronic device of claim 18, wherein the resulting image is generated based on a weighted average of the pixel value of said each pixel adjusted by the weighting factor in each of the plurality of image frames and the pixel value of the corresponding pixel in the reference frame.

24. The electronic device of claim 18, comprising a mobile terminal.
